(19) United States
(12) Patent Application Publication
(10) Pub. No.: US 2025/0334777 A1
(43) Pub. Date: Oct. 30, 2025

(54) IMAGING OPTICAL SYSTEM, IMAGE CAPTURE DEVICE, AND CAMERA SYSTEM

(71) Applicant: Panasonic Intellectual Property Management Co., Ltd., Osaka (JP)

(72) Inventors: Yoshiaki KURIOKA, Osaka (JP); Kunio DOHNO, Osaka (JP)

(21) Appl. No.: 19/181,724

(22) Filed: Apr. 17, 2025

(30) Foreign Application Priority Data
Apr. 25, 2024 (JP) 2024-071914

(51) Int. Cl. G02B 13/00; G02B 9/34; G02B 9/60; G03B 17/14; H04N 23/55

(52) U.S. Cl. CPC G02B 13/0045; G02B 9/34; G02B 9/60; G03B 17/14; H04N 23/55

(57) ABSTRACT

An imaging optical system includes: an aperture stop; a lens LF1 having positive power and located closer to an image plane than, and adjacent to, the aperture stop; a lens LR1 having positive power and located closest to the image plane; a lens LR2 having negative power and located closer to an object than, and adjacent to, the lens LR1; and a lens LR3 having positive power and located closer to the object than, and adjacent to, the lens LR2, and satisfies the following inequalities (1) and (2):

$$0.5 < Linf / Yinf < 2.65 \qquad ( 1 )$$

$$0.5 < BLinf / Yinf < 2.0 \qquad ( 2 )$$

where Linf is a total optical length in an infinity in-focus state,
Yinf is an image height in the infinity in-focus state, and
Blinf is a distance from an image-side surface of the lens located closest to the image plane to the image plane in the infinity in-focus state.

### CROSS-REFERENCE TO RELATED APPLICATIONS

The present application is based upon, and claims the benefit of priority to, Japanese Patent Application No. 2024-071914, filed on Apr. 25, 2024, the entire contents of which are hereby incorporated by reference.

### TECHNICAL FIELD

The present disclosure generally relates to an imaging optical system, an image capture device, and a camera system. More particularly, the present disclosure relates to an imaging optical system having the ability to compensate for various types of aberrations sufficiently and also relates to an image capture device and camera system including such an imaging optical system.

### BACKGROUND ART

JP 2019-184748 A discloses an optical system including a plurality of lens groups and an aperture stop.

In that optical system, the plurality of lens groups consists of: a first lens group B1 having positive refractive power and disposed closer to an object than the aperture stop SP is; and a second lens group B2 having positive refractive power and disposed closer to an image plane than the aperture stop SP is. The first lens group B1 consists of a first positive lens Lp1, a second positive lens Lp2, and a first negative lens Ln1, which are arranged in this order such that the first positive lens Lp1 is located closer to the object than the second positive lens Lp2 or the first negative lens Ln1 is and that the first negative lens Ln1 is located closer to the image plane than the first positive lens Lp1 or the second positive lens Lp2 is. The second lens group B2 consists of at least one lens, a second negative lens Ln2, and a third positive lens Lp3, which are arranged in this order such that the at least one lens is located closer to the object than the second negative lens Ln2 or the third positive lens Lp3 is and that the third positive lens Lp3 is located closer to the image plane than the at least one lens or the second negative lens Ln2 is.

### SUMMARY

The present disclosure provides an imaging optical system having the ability to compensate for various types of aberrations sufficiently, and an image capture device and camera system including such an imaging optical system.

An imaging optical system according to an aspect of the present disclosure includes: an aperture stop; a lens LF1 having positive power and located closer to an image plane than, and adjacent to, the aperture stop; a lens LR1 having positive power and located closest to the image plane; a lens LR2 having negative power and located closer to an object than, and adjacent to, the lens LR1; and a lens LR3 having positive power and located closer to the object than, and adjacent to, the lens LR2. An object-side surface of the lens LR2 is convex toward the image plane. An image-side surface of the lens LR3 is convex toward the image plane. The imaging optical system satisfies the following inequalities (1) and (2):

$$0.5 < Linf / Yinf < 2.65 \qquad ( 1 )$$

$$0.5 < BLinf / Yinf < 2.0 \qquad ( 2 )$$

where Linf is a total optical length of the imaging optical system in an infinity in-focus state,
Yinf is an image height of the imaging optical system in the infinity in-focus state, and
Blinf is a distance from an image-side surface of the lens LR1 located closest to the image plane to the image plane when the imaging optical system is in the infinity in-focus state.

A camera system according to another aspect of the present disclosure includes: an interchangeable lens unit including the imaging optical system described above; and a camera body including: an image sensor configured to receive an optical image of an object formed by the imaging optical system and transform the optical image into an electrical image signal; and a camera mount. The camera body is configured to be connected removably to the interchangeable lens unit via the camera mount. The interchangeable lens unit is configured to form the optical image of the object on the image sensor.

An image capture device according to still another aspect of the present disclosure is configured to transform an optical image of an object into an electrical image signal and display and/or store the electrical image signal thus transformed. The image capture device includes the imaging optical system described above and an image sensor. The imaging optical system is configured to form the optical image of the object. The image sensor transforms the optical image formed by the imaging optical system into the electrical image signal.

### BRIEF DESCRIPTION OF DRAWINGS

The figures depict one or more implementations in accordance with the present teaching, by way of example only, not by way of limitations. In the figures, like reference numerals refer to the same or similar elements.

FIG. 1A illustrates lens arrangements in an imaging optical system according to a first embodiment (corresponding to a first example of numerical values);

FIG. 1B illustrates longitudinal aberration diagrams according to the first example of numerical values;

FIG. 2A illustrates lens arrangements in an imaging optical system according to a second embodiment (corresponding to a second example of numerical values);

FIG. 2B illustrates longitudinal aberration diagrams according to the second example of numerical values;

FIG. 3A illustrates lens arrangements in an imaging optical system according to a third embodiment (corresponding to a third example of numerical values);

FIG. 3B illustrates longitudinal aberration diagrams according to the third example of numerical values;

FIG. 4A illustrates lens arrangements in an imaging optical system according to a fourth embodiment (corresponding to a fourth example of numerical values);

FIG. 4B illustrates longitudinal aberration diagrams according to the fourth example of numerical values;

FIG. 5 illustrates a schematic configuration for an image capture device according to the first embodiment; and

FIG. 6 illustrates a schematic configuration for a lens interchangeable digital camera system according to the first embodiment.

### DETAILED DESCRIPTION

Embodiments of the present disclosure will now be described in detail with reference to the accompanying drawings as appropriate. Note that unnecessarily detailed description will be omitted. For example, detailed description of already well-known matters and redundant description of substantially the same configuration will be omitted. This is done to avoid making the following description overly redundant and thereby help one of ordinary skill in the art understand the present disclosure easily.

In addition, note that the accompanying drawings and the following description are provided by the applicant to help one of ordinary skill in the art understand the present disclosure fully and should not be construed as limiting the scope of the present disclosure, which is defined by the appended claims.

### First to Fourth Embodiments

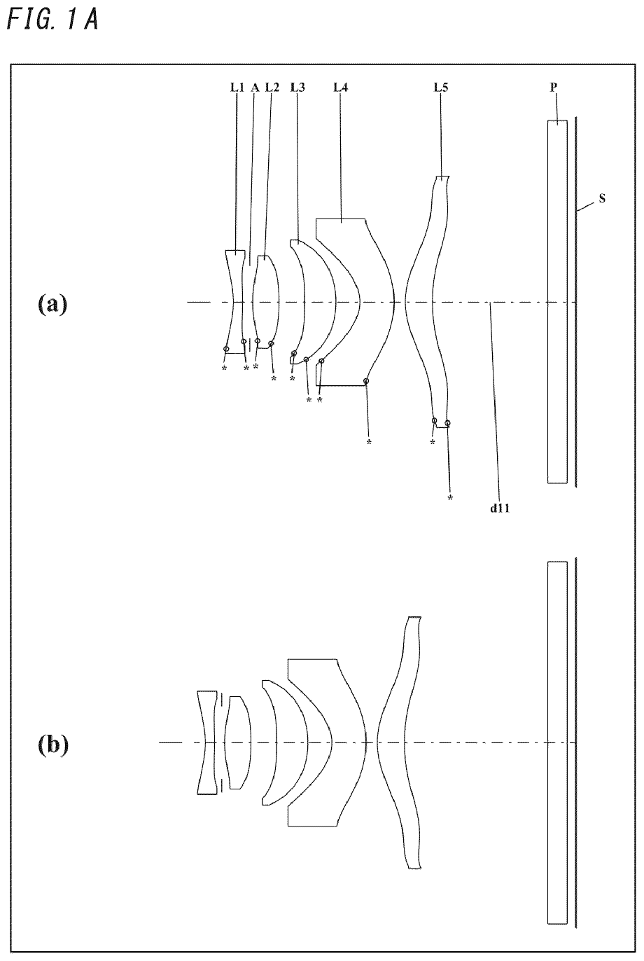

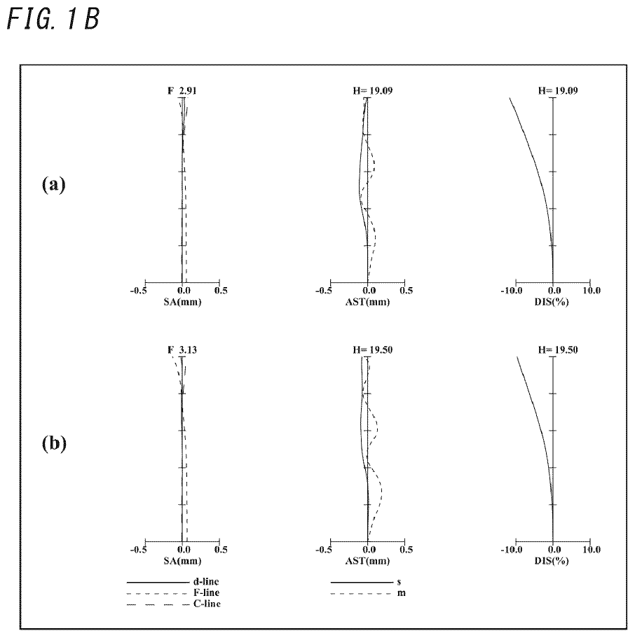

FIGS. 1A, 2A, 3A, and 4A illustrate lens arrangements and operations of an imaging optical system according to first to fourth embodiments, respectively.

As used herein, the terms “in-focus,” “focusing,” and “focus” refer to the imaging optical system which is “in focus” state, “focusing,” and in “focus” unless otherwise stated. In addition, an “optical axis” as used herein refers to the optical axis of the imaging optical system unless otherwise stated.

Portion (a) of FIGS. 1A, 2A, 3A, and 4A illustrates a lens arrangement in the infinity in-focus state. In portion (a) of FIGS. 1A, 2A, 3A, and 4A, the straight line drawn at the right end indicates the position of an image plane S (corresponding to a plane on which an image sensor is disposed, and which faces the object as will be described later). Thus, in each of these drawings, the left side corresponds to an object side. In addition, a low-pass filter or a parallel plate P, for example, may be disposed between the lens group on the last stage, facing the image plane S, of the imaging optical system and the image plane S. Note that respective portions (a) of FIGS. 1A, 2A, 3A, and 4A have the same aspect ratio as the actual aspect ratio.

In portion (a) of FIGS. 1A, 2A, 3A, and 4A, the asterisk (*) attached to a surface of a particular lens indicates that the surface is an aspheric surface. Note that in the lenses, an object-side surface or an image-side surface having no asterisks is a spherical surface.

Portion (b) of each of FIGS. 1A, 2A, 3A, and 4A illustrates a lens arrangement in the close-object in-focus state.

### First Embodiment

An imaging optical system according to a first embodiment will now be described with reference to FIG. 1A.

FIG. 1A illustrates an imaging optical system according to the first embodiment.

The imaging optical system is made up of: a first lens L1 having negative power; an aperture stop A; a second lens L2 having positive power; a third lens L3 having positive power; a fourth lens L4 having negative power; and a fifth lens L5 having positive power. The first lens L1, the aperture stop A, the second lens L2, the third lens L3, the fourth lens L4, and the fifth lens L5 are arranged in this order such that the first lens L1 is located closer to the object than any other member of the imaging optical system is and that the fifth lens L5 is located closer to the image plane than any other member of the imaging optical system is.

A parallel plate P is interposed between the fifth lens L5 and the image plane S.

The imaging optical system forms an image at a point on the image plane S.

The respective lenses will be described.

The first lens L1 is a meniscus lens having a convex surface facing the image plane. Each of the two surfaces of the first lens L1 has an aspheric shape. The first lens L1 is an example of the lens group having negative power.

The second lens L2 is a biconvex lens. Each of the two surfaces of the second lens L2 has an aspheric shape. The second lens L2 is an example of the lens LF1.

The third lens L3 is a meniscus lens having a convex surface facing the image plane. Each of the two surfaces of the third lens L3 has an aspheric shape. The third lens L3 is an example of the lens LR3.

The fourth lens L4 is a meniscus lens having a convex surface facing the image plane. Each of the two surfaces of the fourth lens L4 has an aspheric shape. The fourth lens L4 is an example of the lens LR2.

The fifth lens L5 is a meniscus lens having a convex surface facing the object. Each of the two surfaces of the fifth lens L5 has an aspheric shape. The fifth lens L5 is an example of the lens LR1.

While the imaging optical system according to the first embodiment is focusing to make a transition from the infinity in-focus state to the close-object in-focus state during a shooting session, the first lens L1, the second lens L2, the third lens L3, the fourth lens L4, and the fifth lens L5 all move toward the object with respect to the image plane S. In addition, while the imaging optical system is focusing to make the transition from the infinity in-focus state to the close-object in-focus state during the shooting session, the interval between two adjacent lenses is constant.

### Second Embodiment

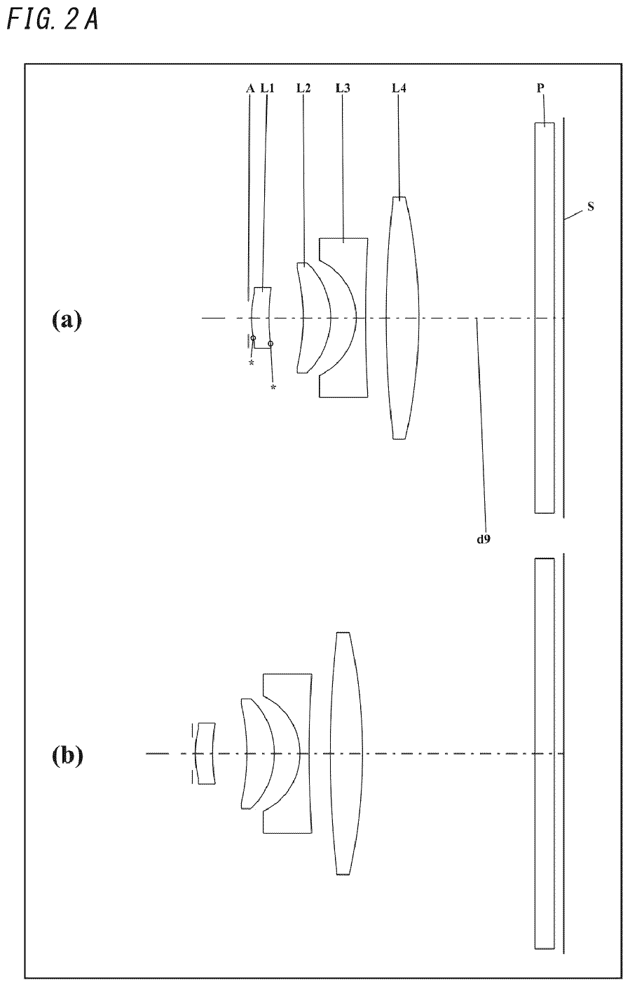

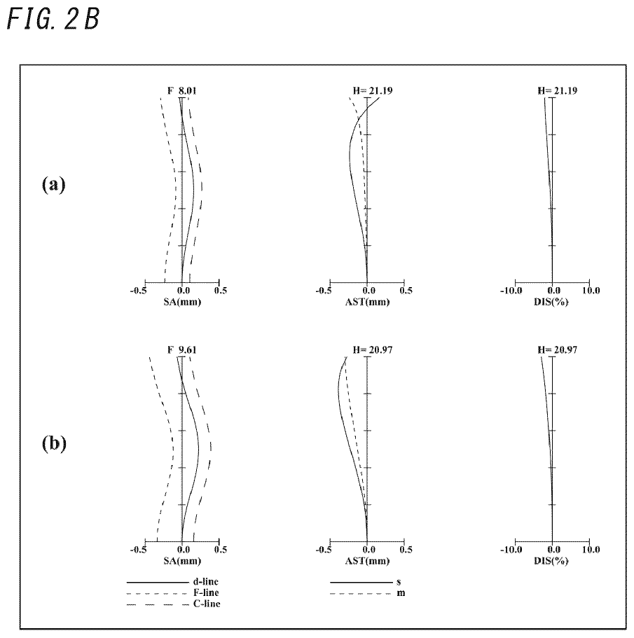

An imaging optical system according to a second embodiment will now be described with reference to FIG. 2A.

FIG. 2A illustrates an imaging optical system according to the second embodiment.

The imaging optical system is made up of: an aperture stop A; a first lens L1 having positive power; a second lens L2 having positive power; a third lens L3 having negative power; and a fourth lens L4 having positive power. The aperture stop A, the first lens L1, the second lens L2, the third lens L3, and the fourth lens L4 are arranged in this order such that the aperture stop A is located closer to the object than any other member of the imaging optical system is and that the fourth lens L4 is located closer to the image plane than any other member of the imaging optical system is.

A parallel plate P is interposed between the fourth lens L4 and the image plane S.

The imaging optical system forms an image at a point on the image plane S.

The respective lenses will be described.

The first lens L1 is a meniscus lens having a convex surface facing the object. Each of the two surfaces of the first lens L1 has an aspheric shape. The first lens L1 is an example of the lens LF1.

The second lens L2 is a meniscus lens having a convex surface facing the image plane. The second lens L2 is an example of the lens LR3.

The third lens L3 is a biconcave lens. The third lens L3 is an example of the lens LR2.

The fourth lens L4 is a biconvex lens. The fourth lens L4 is an example of the lens LR1.

While the imaging optical system according to the second embodiment is focusing to make a transition from the infinity in-focus state to the close-object in-focus state during a shooting session, the first lens L1, the second lens L2, the third lens L3, and the fourth lens L4 all move toward the object with respect to the image plane S. In addition, while the imaging optical system is focusing to make the transition from the infinity in-focus state to the close-object in-focus state during the shooting session, the interval between two adjacent lenses is constant.

### Third Embodiment

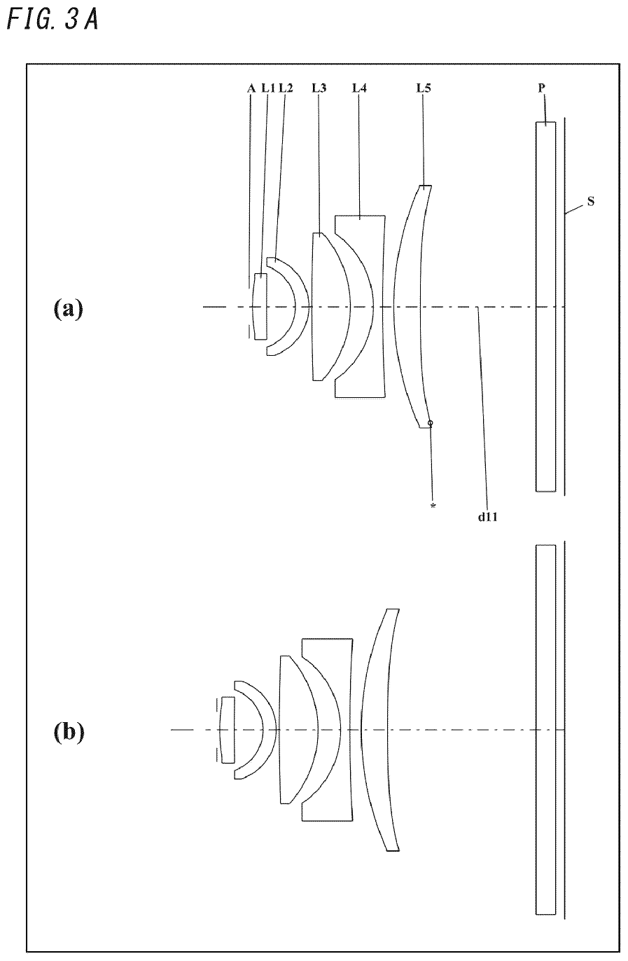

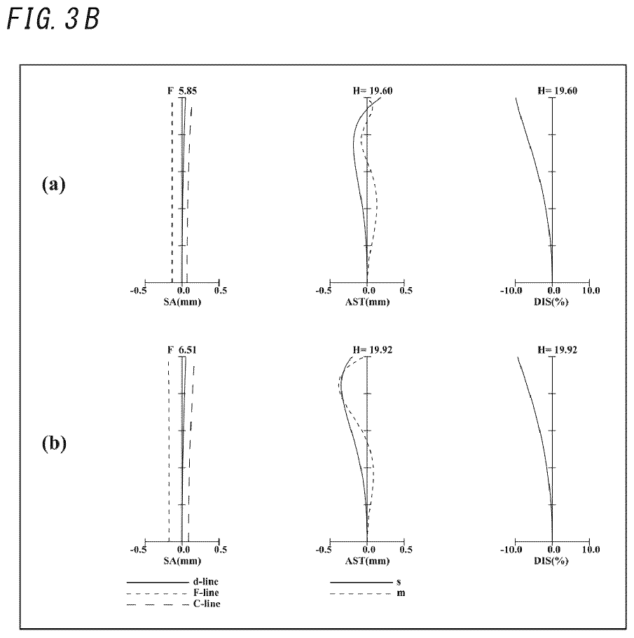

An imaging optical system according to a third embodiment will now be described with reference to FIG. 3A.

FIG. 3A illustrates an imaging optical system according to the third embodiment.

The imaging optical system includes: an aperture stop A; a first lens L1 having positive power; a second lens L2 having negative power; a third lens L3 having positive power; a fourth lens L4 having negative power; and a fifth lens L5 having positive power. The aperture stop A, the first lens L1, the second lens L2, the third lens L3, the fourth lens L4, and the fifth lens L5 are arranged in this order such that the aperture stop A is located closer to the object than any other member of the imaging optical system is and that the fifth lens L5 is located closer to the image plane than any other member of the imaging optical system is.

A parallel plate P is interposed between the fifth lens L5 and the image plane S.

The imaging optical system forms an image at a point on the image plane S.

The respective lenses will be described.

The first lens L1 is a meniscus lens having a convex surface facing the object. The first lens L1 is an example of the lens LF1.

The second lens L2 is a meniscus lens having a convex surface facing the image plane.

The third lens L3 is a biconvex lens. The third lens L3 is an example of the lens LR3.

The fourth lens L4 is a biconcave lens. The fourth lens L4 is an example of the lens LR2.

The fifth lens L5 is a meniscus lens having a convex surface facing the object. The fifth lens L5 is an example of the lens LR1.

While the imaging optical system according to the third embodiment is focusing to make a transition from the infinity in-focus state to the close-object in-focus state during a shooting session, the first lens L1, the second lens L2, the third lens L3, the fourth lens L4, and the fifth lens L5 all move toward the object with respect to the image plane S. In addition, while the imaging optical system is focusing to make the transition from the infinity in-focus state to the close-object in-focus state during the shooting session, the interval between two adjacent lenses is constant.

### Fourth Embodiment

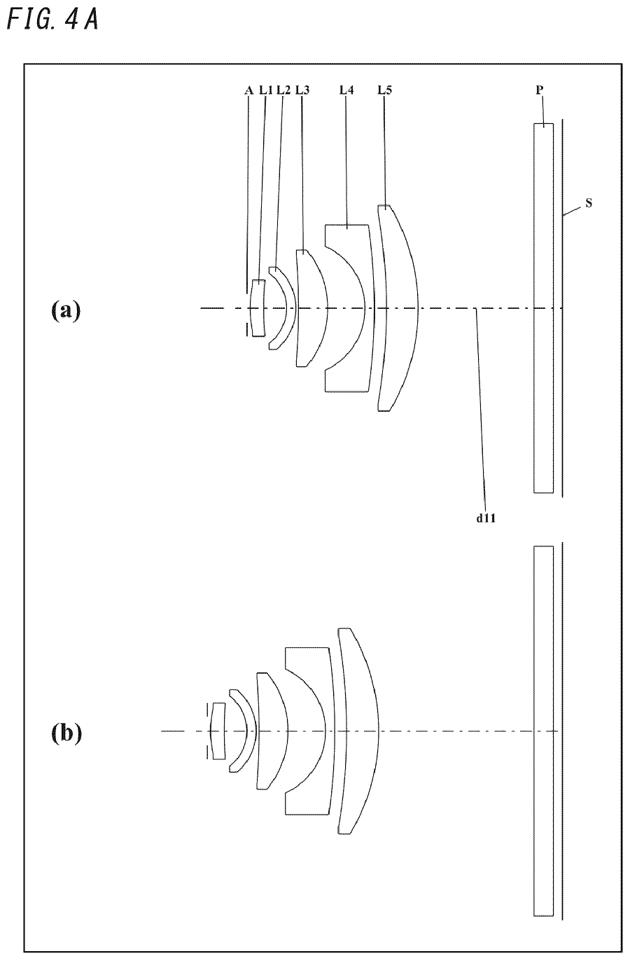

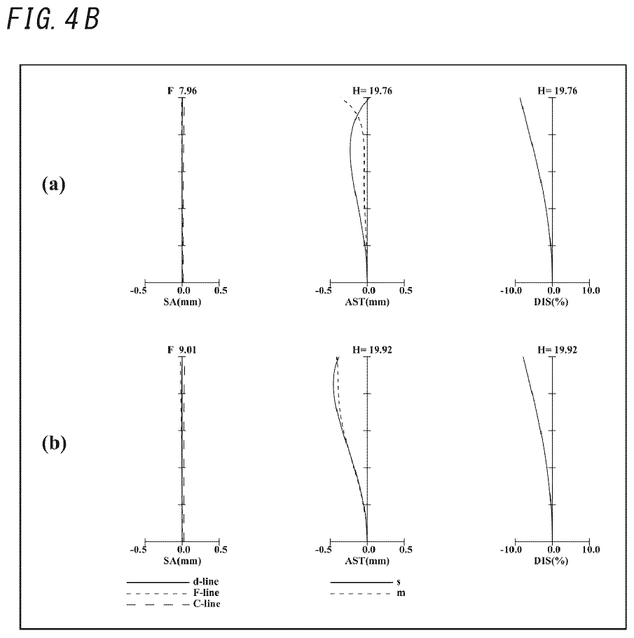

An imaging optical system according to a fourth embodiment will now be described with reference to FIG. 4A.

FIG. 4A illustrates an imaging optical system according to the fourth embodiment.

The imaging optical system is made up of: an aperture stop A; a first lens L1 having positive power; a second lens L2 having negative power; a third lens L3 having positive power; a fourth lens L4 having negative power; and a fifth lens L5 having positive power. The aperture stop A, the first lens L1, the second lens L2, the third lens L3, the fourth lens L4, and the fifth lens L5 are arranged in this order such that the aperture stop A is located closer to the object than any other member of the imaging optical system is and that the fifth lens L5 is located closer to the image plane than any other member of the imaging optical system is.

A parallel plate P is interposed between the fifth lens L5 and the image plane S.

The imaging optical system forms an image at a point on the image plane S.

The respective lenses will be described.

The first lens L1 is a meniscus lens having a convex surface facing the object. The first lens L1 is an example of the lens LF1.

The second lens L2 is a meniscus lens having a convex surface facing the image plane.

The third lens L3 is a meniscus lens having a convex surface facing the image plane. The third lens L3 is an example of the lens LR3.

The fourth lens L4 is a meniscus lens having a convex surface facing the image plane. The fourth lens L4 is an example of the lens LR2.

The fifth lens L5 is a meniscus lens having a convex surface facing the image plane. The fifth lens L5 is an example of the lens LR1.

While the imaging optical system according to the fourth embodiment is focusing to make a transition from the infinity in-focus state to the close-object in-focus state during a shooting session, the first lens L1, the second lens L2, the third lens L3, the fourth lens L4, and the fifth lens L5 all move toward the object with respect to the image plane S. In addition, while the imaging optical system is focusing to make the transition from the infinity in-focus state to the close-object in-focus state during the shooting session, the interval between two adjacent lenses is constant.

### Conditions and Advantages

Next, conditions that an imaging optical system such as the ones according to the first to fourth embodiments described above may satisfy will be described. That is to say, a plurality of conditions may be defined for the imaging optical system according to each of these four embodiments. In that case, an imaging optical system, of which the configuration satisfies all of these conditions, is most advantageous. Alternatively, an imaging optical system that achieves its expected advantages by satisfying any of the individual conditions to be described below may also be provided.

For example, as in the imaging optical systems according to the first through fourth embodiments described above, an imaging optical system according to the present disclosure includes: an aperture stop; a lens LF1 having positive power and located closer to an image plane than, and adjacent to, the aperture stop; a lens LR1 having positive power and located closest to the image plane; a lens LR2 having negative power and located closer to an object than, and adjacent to, the lens LR1; and a lens LR3 having positive power and located closer to the object than, and adjacent to, the lens LR2. This configuration will be hereinafter referred to as a “basic configuration.”

This basic configuration allows for providing a high-performance lens of a small size.

Also, in the imaging optical system, an object-side surface of the lens LR2 is preferably convex toward the image plane. An image-side surface of the lens LR3 is preferably convex toward the image plane.

The imaging optical system preferably satisfies the following inequality (1):

$$0.5 < Linf / Yinf < 2.65 \qquad ( 1 )$$

where Linf is a total optical length of the imaging optical system in an infinity in-focus state, and
Yinf is an image height of the imaging optical system in the infinity in-focus state.

The condition expressed by this inequality (1) defines the ratio of a total optical length of the imaging optical system in the infinity in-focus state (i.e., a distance measured on the optical axis from either a surface on which the aperture stop A is located or an object-side surface of a lens located closest to the object, whichever is located closer to the object, to the image plane S) to an image height of the imaging optical system in the infinity in-focus state (which is approximately equal to the length from the center of an image sensor to an opposing corner).

If the Linf/Yinf ratio were less than the lower limit value set by this inequality (1), then the optical system would be so small as to make it difficult to compensate for aberrations, which is not beneficial. On the other hand, if the Linf/Yinf ratio were greater than the upper limit value set by this inequality (1), then the optical system would be oversized, which is not beneficial, either.

To enhance the advantage described above, the condition(s) expressed by one or both of the following inequalities (1a) and (1b) is/are preferably satisfied:

$$0.8 < Linf / Yinf \qquad ( 1 a )$$

$$Linf / Yinf < 2 \text{.40} . \qquad ( 1 b )$$

More preferably, to further enhance the advantage described above, the condition(s) expressed by one or both of the following inequalities (1c) and (1d) is/are satisfied:

$$1.3 < Linf / Yinf \qquad ( 1 c )$$

$$Linf / Yinf < 2 \text{.20} . \qquad ( 1 d )$$

In addition, the imaging optical system preferably satisfies, for example, the following inequality (2):

$$0.5 < BLinf / Yinf < 2.0 \qquad ( 2 )$$

where Yinf is an image height of the imaging optical system in the infinity in-focus state, and
Blinf is a distance from an image-side surface of the lens LR1 located closest to the image plane to the image plane S when the imaging optical system is in the infinity in-focus state.

The condition expressed by the inequality (2) defines the ratio of an image height of the imaging optical system in the infinity in-focus state (which is approximately equal to the length from the center of the image sensor to an opposing corner) to a distance from an image-side surface of the lens LR1 located closest to the image plane to the image plane S when the imaging optical system is in the infinity in-focus state.

If the BLinf/Yinf ratio were less than the lower limit value set by this inequality (2), then the distance from the image-side surface of the lens LR1 located closest to the image plane to the image plane S would decrease so much as to make it difficult to dispose a member for coupling the imaging optical system to the image sensor to be placed on the image plane S, which is not beneficial. On the other hand, if the BLinf/Yinf ratio were greater than the upper limit value set by this inequality (2), then the distance from the image-side surface of the lens LR1 located closest to the image plane to the image plane S would increase so much as to make the imaging optical system oversized, which is not beneficial, either.

To enhance the advantage described above, the condition(s) expressed by one or both of the following inequalities (2a) and (2b) is/are preferably satisfied:

$$0.6 < BLinf / Yinf \qquad ( 2 a )$$

$$BLinf / Yinf < 1.5 . \qquad ( 2 b )$$

More preferably, to further enhance the advantage described above, the condition(s) expressed by one or both of the following inequalities (2c) and (2d) is/are satisfied:

$$0.7 < BLinf / Yinf \qquad ( 2 c )$$

$$BLinf / Yinf < 1. . \qquad ( 2 d )$$

The imaging optical system preferably includes a lens group having negative power and located not only closest to the object but also closer to the object than, and adjacent to, the aperture stop A.

Arranging the aperture stop A to be located closer to the object than the lens LF1 having positive power may make the interval from the lens located closest to the object to the lens located closest to the image plane shorter. In addition, arranging the lens group having negative power to be located closer to the object than the aperture stop A makes it easier, by downsizing, to compensate for aberrations of the lens group that is arranged to be located closer to the image plane than the aperture stop A having strong positive power.

The imaging optical system may include a lens having negative power and located closer to the object than, and adjacent to, the aperture stop A.

This may make the interval from the lens having negative power and located closer to the object than, and adjacent to, the aperture stop A to the lens located closest to the image plane shorter. In addition, this also makes it easier, by downsizing, to compensate for aberrations of the lens group that is arranged to be located closer to the image plane than the aperture stop A having strong positive power.

The imaging optical system preferably satisfies, for example, the following inequality (3):

$$nd\_LF1 < 1.65 \qquad ( 3 )$$

where nd_LF1 is a refractive index of the lens LF1.

The condition expressed by this inequality (3) defines the refractive index of the lens LF1.

If nd_LF1 were greater than the upper limit value set by this inequality (3), then the spherical aberration would be positively biased, which is not beneficial.

To enhance the advantage described above, the condition expressed by the following inequality (3a) is preferably satisfied:

$$nd\_LF1 < 1.6 . \qquad ( 3 a )$$

More preferably, to further enhance the advantage described above, the condition expressed by the following inequality (3b) is satisfied:

$$nd\_LF1 < 1.55 . \qquad ( 3 b )$$

Even more preferably, the imaging optical system satisfies not only any one of the inequalities (3), (3a), and (3b) but also the following inequality (3c):

$$1.4 < nd\_LF1 . \qquad ( 3 c )$$

If nd_LF1 were less than the lower limit value set by this inequality (3c), then the spherical aberration would be negatively biased.

The imaging optical system preferably satisfies, for example, the following inequality (4):

$$50 < vd\_LF1 \qquad ( 4 )$$

where vd_LF1 is an abbe number of the lens LF1.

The condition expressed by the inequality (4) defines an abbe number of the lens LF1.

If vd_LF1 were less than the lower limit value set by this inequality (4), then the axial chromatic aberration would increase, which is not beneficial.

To enhance the advantage described above, the condition expressed by the following inequality (4a) is preferably satisfied:

$$60 < vd\_LF1 . \qquad ( 4 a )$$

Even more preferably, the imaging optical system satisfies not only any one of the inequalities (4) and (4a) but also the following inequality (4b):

$$vd\_LF1 < 100 . \qquad ( 4 b )$$

If vd_LF were greater than the upper limit value set by this inequality (4b), then a glass material having a desired abbe number would run so short as to make it difficult to select a material for the lens.

In the imaging optical system, a lens located closer to the image plane than, and adjacent to, the lens LF1 preferably has an object-side surface convex toward the image plane.

This makes it easier to compensate for various types of aberrations such as spherical aberration, among other things.

The imaging optical system preferably includes a plurality of lenses located closer to the image plane than the aperture stop A is. The number of the plurality of lenses is preferably equal to or greater than three and equal to or less than six.

Providing two or less lenses which are located closer to the image plane than the aperture stop A would make it difficult to compensate for aberrations, which is not beneficial. On the other hand, providing seven or more lenses which are located closer to the image plane than the aperture stop A would make the optical system oversized, which is not beneficial, either.

While the imaging optical system is focusing to make a transition from the infinity in-focus state to a close-object in-focus state, at least a plurality of lenses, ranging from the lens LF1 located closer to the image plane than, and adjacent to, the aperture stop A through the lens LR1 located closest to the image plane, preferably move along with each other.

This makes it easier to compensate for aberrations while the imaging optical system is focusing to make the transition from the infinity in-focus state to the close-object in-focus state. Optionally, a plurality of lenses, ranging from the lens LF1 located closer to the image plane than, and adjacent to, the aperture stop A through the lens LR1 located closest to the image plane, may move along with the aperture stop A. Making the aperture stop A move along with these lenses allows the interval during the focusing to be shortened, thus making it easier to reduce the overall size of the imaging optical system.

The imaging optical system preferably satisfies, for example, the following inequality (5):

$$- 1. < ( R 1 \_LR 2 - R 2 \_LR 3 ) / ( R 1 \_LR 2 + R 2 \_LR 3 ) < 0.5 \qquad ( 5 )$$

where R1 LR2 is a radius of curvature of an object-side surface of the lens LR2, and
R2 LR3 is a radius of curvature of an image-side surface of the lens LR3.

The condition expressed by the inequality (5) defines the shape factor of an air lens between the radius of curvature of an object-side surface of the lens LR2 and a radius of curvature of an image-side surface of the lens LR3.

If this ratio were less than the lower limit set by this inequality (5), then the spherical aberration would be excessively positively biased, which is not beneficial. On the other hand, if the ratio were greater than the upper limit set by this inequality (5), then the spherical aberration would be excessively negatively biased, which is not beneficial, either.

To enhance the advantage described above, the condition(s) expressed by one or both of the following inequalities (5a) and (5b) is/are preferably satisfied:

$$- 0.7 < ( R1\_LR2 - R2\_LR3 ) / ( R 1 \_LR2 + R2\_LR3 ) \qquad ( 5 a )$$

$$( R1\_LR 2 - R2\_LR3 ) / ( R1\_LR2 + R2\_LR3 ) < 0.2 . \qquad ( 5 b )$$

More preferably, to further enhance the advantage described above, the condition(s) expressed by one or both of the following inequalities (5c) and (5d) is/are satisfied:

$$- 0.5 < ( R1\_LR2 - R2\_LR3 ) / ( R1\_LR2 + R2\_LR3 ) \qquad ( 5 c )$$

$$( R1\_LR2 - R2\_LR3 ) / ( R1\_LR2 + R2\_LR3 ) < 0. . \qquad ( 5 d )$$

The imaging optical system preferably satisfies, for example, the following inequality (6):

$$0.5 < L\_ss \_LR1R2 / Yinf < 3. \qquad ( 6 )$$

where L_ss_LR1R2 is a distance from the aperture stop A to an image-side surface of the lens LR1 when the imaging optical system is in the infinity in-focus state, and
Yinf is an image height of the imaging optical system in the infinity in-focus state.

The condition expressed by this inequality (6) defines the ratio of the distance from the aperture stop A to an image-side surface of the lens LR1 when the imaging optical system is in the infinity in-focus state to an image height (which is approximately equal to the distance from the center of the image sensor to the opposing corner) of the imaging optical system in the infinity in-focus state.

If the L_ss_LR1R2/Yinf ratio were less than the lower limit value set by this inequality (6), then the aperture stop A would be so close to the image plane S and the angle of incidence on the image plane S would be so large as to cause a decline in the efficiency of incidence onto the image sensor, which is not beneficial. On the other hand, if the L_ss_LR1R2/Yinf ratio were greater than the upper limit value set by this inequality (6), then the optical system would be oversized, which is not beneficial, either.

To enhance the advantage described above, the condition(s) expressed by one or both of the following inequalities (6a) and (6b) is/are preferably satisfied:

$$0.6 < L\_ss \_LR1R2 / Yinf \qquad ( 6 a )$$

$$L\_ss \_LR1R2 / Yinf < 2. . \qquad ( 6 b )$$

More preferably, to further enhance the advantage described above, the condition(s) expressed by one or both of the following inequalities (6c) and (6d) is/are satisfied:

$$0.7 < L\_ss \_LR1R2 / Yinf \qquad ( 6 c )$$

$$L\_ss \_LR1R2 / Yinf < 1.1 . \qquad ( 6 d )$$

The imaging optical system preferably satisfies, for example, the following inequality (7):

$$0.2 < L\_tsum / L\_LR1R2 < 0.9 \qquad ( 7 )$$

where L_tsum is a sum of respective thicknesses of all lenses included in the imaging optical system, and

L_LR1R2 is a distance measured on the optical axis from a surface, located closest to the object, in the imaging optical system to an image-side surface of the lens LR1 located closest to the image plane.

The condition expressed by this inequality (7) defines the ratio of the sum of respective thicknesses of all lenses included in the imaging optical system to a distance measured on the optical axis from a surface, located closest to the object, of the imaging optical system (i.e., either the surface on which the aperture stop A is located or the object-side surface of the lens located closest to the object, whichever is located closer to the object) to an image-side surface of the lens LR1 located closest to the image plane.

If the L_tsum/L_LR1R2 ratio were less than the lower limit value set by this inequality (7), then the lens would be so thin as to make it difficult to form the shape required for compensating for aberrations, which is not beneficial. On the other hand, if the L_tsum/L_LR1R2 ratio were greater than the upper limit value set by this inequality (7), then the air gap between the lenses would be so narrow as to make it difficult to hold the lenses, which is not beneficial, either.

To enhance the advantage described above, the condition(s) expressed by one or both of the following inequalities (7a) and (7b) is/are preferably satisfied:

$$0.3 < L\_tsum / L\_LR1R2 \qquad ( 7 a )$$

$$L\_tsum / L\_LR1R2 < 0.7 . \qquad ( 7 b )$$

More preferably, to further enhance the advantage described above, the condition(s) expressed by one or both of the following inequalities (7c) and (7d) is/are satisfied:

$$0.4 < L\_tsum / L\_LR1R2 \qquad ( 7 c )$$

$$L\_tsum / L\_LR1R2 < 0.7 . \qquad ( 7 d )$$

The imaging optical system preferably satisfies the following inequality (8):

$$0.03 < EA\_L1R1 / finf < 0.5 \qquad ( 8 )$$

where EA_L1R1 is an effective diameter of an object-side surface of a lens located closest to the object, and
finf is a focal length of the imaging optical system in the infinity in-focus state.

The condition expressed by this inequality (8) defines the ratio of an effective diameter of an object-side surface of a lens located closest to the object (which may be regarded as the radius of a frontend lens of the imaging optical system) to a focal length of the imaging optical system in the infinity in-focus state.

If the EA_L1R1/finf ratio were less than the lower limit set by this inequality (8), then the beam diameter of an incoming light beam would be so small as to make it difficult to achieve a practical F value, which is not beneficial. On the other hand, if the EA_L1R1/finf ratio were greater than the upper limit value set by this inequality (8), then it would be difficult to provide an optical system of a small size, which is not beneficial, either.

To enhance the advantage described above, the condition(s) expressed by one or both of the following inequalities (8a) and (8b) is/are preferably satisfied:

$$0.05 < EA\_L1R1 / finf \qquad ( 8 a )$$

$$EA\_L1R1 / finf < 0.3 . \qquad ( 8 b )$$

More preferably, to further enhance the advantage described above, the condition(s) expressed by one or both of the following inequalities (8a) and (8b) is/are satisfied:

$$0.07 < EA\_L1R1 / finf \qquad ( 8 c )$$

$$EA\_L1R1 / finf < 0.26 . \qquad ( 8 d )$$

The imaging optical system preferably satisfies, for example, the following inequality (9):

$$0.01 < L\_ss \_LF1R1 / Yinf < 0.2 \qquad ( 9 )$$

where L_ss_LF1R1 is a distance measured on the optical axis from the aperture stop A to an object-side surface of the lens LF1 when the imaging optical system is in the infinity in-focus state, and
Yinf is an image height of the imaging optical system in the infinity in-focus state.

The condition expressed by this inequality (9) defines the ratio of a distance measured on the optical axis from the aperture stop A to an object-side surface of the lens LF1 when the imaging optical system is in the infinity in-focus state to an image height (which is approximately equal to the length from the center of the image sensor to an opposing corner) of the imaging optical system in the infinity in-focus state.

If the L_ss_LF1R1/Yinf ratio were less than the lower limit set by this inequality (9), then the interval between the lens LF1 and the aperture stop A would be so narrow as to make it difficult to arrange the aperture stop A, which is not beneficial. On the other hand, if the L_ss_LF1R1/Yinf ratio were greater than the upper limit value set by this inequality (9), then the interval between the lens LF1 and the aperture stop A would be so wide as to make the lens group located closer to the image plane than the aperture stop A oversized, which is not beneficial, either.

To enhance the advantage described above, the condition expressed by the following inequality (9a) is preferably satisfied:

$$L\_ss \_LF1R1 / Yinf < 0.15 \qquad ( 9 a )$$

More preferably, to further enhance the advantage described above, the condition expressed by the following inequality (9b) is satisfied:

$$L\_ss \_LF1R1 / Yinf < 0.1 \qquad ( 9 b )$$

In the imaging optical system according to the basic configuration, for example, either the aperture stop A or a lens having power and located closer to the object than, and adjacent to, the aperture stop A is preferably located closest to the object in the imaging optical system.

This allows for providing an optical system of a small size.

### Schematic Configuration for Image Capture Device to Which First Embodiment is Applied

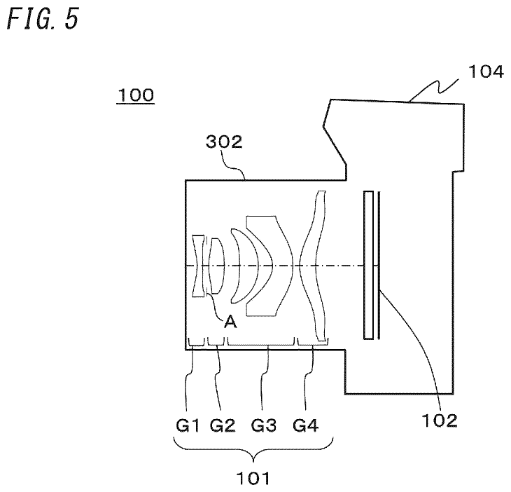

FIG. 5 illustrates a schematic configuration for an image capture device, to which the imaging optical system of the first embodiment is applied. Optionally, the imaging optical system according to any one of the second to fourth embodiment is also applicable to the image capture device.

The image capture device 100 includes a housing 104, an image sensor 102, and the imaging optical system 101 according to the first embodiment. Specifically, the image capture device 100 may be implemented as a digital camera, for example. In the example shown in FIG. 5, the imaging optical system 101 includes first to fourth lens groups G1-G4. The first lens group G1 includes a first lens L1. The second lens group G2 includes a second lens L2. The third lens group G3 includes a third lens L3 and a fourth lens L4. The fourth lens group G4 includes a fifth lens L5.

The housing 104 includes a lens barrel 302. The lens barrel 302 holds the respective lenses of the imaging optical system 101 and the aperture stop A.

The image sensor 102 is disposed at the image plane S of the imaging optical system 101 according to the first embodiment.

The imaging optical system 101 is configured such that to allow the first lens L1, the second lens L2, the third lens L3, the fourth lens L4, and the fifth lens L5 to move along with each other while the imaging optical system is focusing to make a transition from the infinity in-focus state to the close-object in-focus state, a lens frame included in the lens barrel 302 is attached to, or engaged with, these lenses. Optionally, to allow the aperture stop A to move as well along with these lenses during focusing, the aperture stop A may be attached to, or engaged with, the lens frame included in the lens barrel 302.

In the image capture device 100 including the imaging optical system 301 that includes the respective lenses held by the lens barrel 302, an actuator, a lens frame, and other members to be controlled by a controller in the image capture device 100 are provided such that the first lens L1, the second lens L2, the third lens L3, the fourth lens L4, and the fifth lens L5 may move along with each other while the imaging optical system is focusing.

This allows for providing an image capture device having the ability to compensate for various types of aberrations sufficiently.

In the example described above, the imaging optical system according to the first embodiment is applied to a digital camera. However, this is only an example and should not be construed as limiting. Alternatively, the imaging optical system is also applicable to a digital camcorder, a surveillance camera, a smartphone, or any of various other types of image capture devices.

### Schematic Configuration for Camera System to Which First Embodiment is Applied

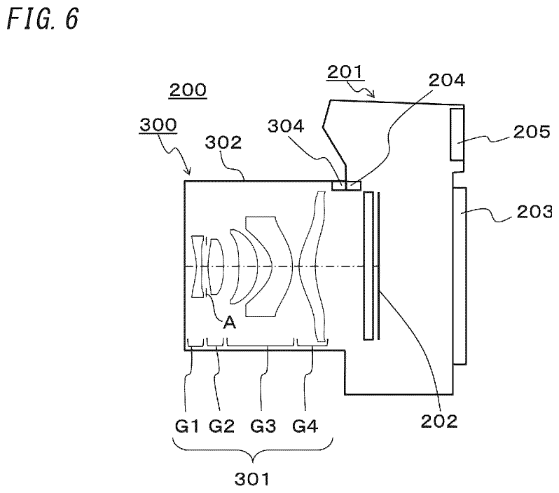

FIG. 6 illustrates a schematic configuration for a camera system, to which the imaging optical system of the first embodiment is applied. Alternatively, the imaging optical system according to any one of the second to fourth embodiments is also applicable to the camera system.

The camera system 200 includes a camera body 201 and an interchangeable lens unit 300 to be connected removably to the camera body 201.

The camera body 201 includes an image sensor 202, a monitor 203, a memory, a camera mount 204, and a viewfinder 205. The image sensor 202 receives an optical image of an object formed by the imaging optical system 301 of the interchangeable lens unit 300 and transforms the optical image into an electrical image signal. The monitor 203 displays the electrical image signal transformed by the image sensor 202. The memory stores the electrical image signal.

The imaging optical system 301 of the interchangeable lens unit 300 is the imaging optical system according to the first embodiment. In the example shown in FIG. 6, the imaging optical system 301 includes first to fourth lens groups G1-G4. The first lens group G1 includes a first lens L1. The second lens group G2 includes a second lens L2. The third lens group G3 includes a third lens L3 and a fourth lens L4. The fourth lens group G4 includes a fifth lens L5.

The interchangeable lens unit 300 includes not only the imaging optical system 301 but also a lens barrel 302 and a lens mount 304. The lens barrel 302 holds the respective lenses and aperture stop A of the imaging optical system 301. The lens mount 304 is connected to the camera mount 204 of the camera body 201.

In this manner, the camera mount 204 and the lens mount 304 are physically connected together. In addition, the camera mount 204 and the lens mount 304 also electrically connect together a controller in the camera body 201 and a controller in the interchangeable lens unit 300. That is to say, the camera mount 204 and the lens mount 304 also serve as interfaces that allow themselves to transmit and receive signals to/from each other.

The camera system 200 is configured such that to allow the first lens L1, the second lens L2, the third lens L3, the fourth lens L4, and the fifth lens L5 to move along with each other while the imaging optical system is focusing, a lens frame included in the lens barrel 302 is attached to, or engaged with, these lenses. Optionally, to allow the aperture stop A to move as well along with these lenses while the imaging optical system is focusing, the aperture stop A may be attached to, or engaged with, the lens frame included in the lens barrel 302.

This allows for providing a camera system having the ability to compensate for various types of aberrations sufficiently.

In the example described above, the imaging optical system according to the first embodiment is applied to a digital camera. However, this is only an example and should not be construed as limiting. Alternatively, the imaging optical system is also applicable to a digital camcorder, a surveillance camera, a smartphone, or any of various other types of image capture devices.

### Other Embodiments

The first through fourth embodiments have been described as exemplary embodiments of the present disclosure. Note that the embodiments described above are only examples of the present disclosure and should not be construed as limiting. Rather, each of those embodiments may be readily modified, replaced, combined with other embodiments, provided with some additional components, or partially omitted without departing from the scope of the present disclosure.

In the first to fourth embodiments described above, each of the lens groups that form the imaging optical system is supposed to consist of only refractive lenses that deflect an incoming light ray through refraction (i.e., lenses of the type that deflect the incoming light ray at the interface between two media with mutually different refractive indices). However, this is only an example and should not be construed as limiting. Alternatively, each lens group may also include diffractive lenses that deflect the incoming light ray through diffraction, refractive-diffractive hybrid lenses that deflect the incoming light ray through a combination of diffraction and refraction, or refractive index distributed lenses that deflect the incoming light ray in accordance with the distribution of refractive indices in the medium, or a combination of two or more types of these lenses. Among other things, a diffraction structure is preferably formed at the interface between two media with mutually different refractive indices in the refractive-diffractive hybrid lenses, because the diffraction efficiency would depend on the wavelength much less heavily in that case. This allows for providing a camera with the ability to compensate for various types of aberrations sufficiently.

In the first embodiment described above, the first lens L1 is supposed to form an exemplary lens group having negative power and located closer to the object than the aperture stop A is. However, this is only an example and should not be construed as limiting. Alternatively, the lens group having negative power may also be made up of a plurality of single lenses and/or a bonded lens and may have negative power as its composite power. Thus, the lens group having negative power does not have to consist of a negative single lens.

Nevertheless, if the lens group having negative power is made up of a lens having negative power and another lens having negative power which are arranged in this order such that the former lens is located closer to the object than the latter lens, then the aberrations produced by a lens having positive power and located closer to the image plane than the aperture stop A may be compensated for more easily. Furthermore, the image-side surface of a lens having negative power and located closest to the object in the lens group having negative power may be convex toward the object. This makes it even easier to compensate for aberrations through the peripheral portions as well.

Furthermore, if the lens group having negative power is made up of a lens having positive power, a lens having negative power, and another lens having negative power, which are arranged in this order such that the lens having positive power is located closer to the object than any of the two other lenses each having negative power, then such an arrangement may prevent the imaging optical system from having too large a back focus. Optionally, the image-side surface of a lens having negative power and located second closest to the object in the lens group having negative power may be convex toward the object. This makes it even easier to compensate for aberrations through the peripheral portions as well.

Furthermore, if the lens group having negative power is made up of a lens having negative power, a lens having positive power, and another lens having negative power, which are arranged in this order such that the former lens having negative power is located closer to the object than any of the two other lenses, then such an arrangement makes it easier to compensate for aberrations within the lens group having negative power and located closer to the object than the aperture stop A is while making it easier to compensate for the aberrations produced by the lens LF1 having positive power and located closer to the image plane than the aperture stop A is. Optionally, the image-side surface of a lens having negative power and located closest to the object in the lens group having negative power may be convex toward the object. This makes it even easier to compensate for aberrations through the peripheral portions as well.

Furthermore, if the lens group having negative power is made up of a lens having negative power, another lens having negative power, a lens having positive power, and still another lens having negative power which are arranged in this order such that the former lens having negative power is located closer to the object than any of the three other lenses, then such an arrangement makes it easier to compensate for aberrations in the peripheral portions of even an imaging optical system having as wide an angle of view as 40 to 60 degrees. Optionally, the image-side surface of a lens having negative power and located closest to the object in the lens group having negative power may be convex toward the object. This makes it even easier to compensate for aberrations through the peripheral portions as well.

### Examples of Numerical Values

Next, exemplary sets of specific numerical values that were actually adopted in the imaging optical systems with the configurations according to the first through fourth embodiments will be described. The imaging optical systems used in the first through fourth examples of numerical values to be described below correspond to the first through fourth embodiments shown in FIGS. 1A, 2A, 3A, and 4A, respectively. Note that in the tables showing these exemplary sets of numerical values, the length is expressed in millimeters (mm), the angle of view is expressed in degrees (°), r indicates the radius of curvature, d indicates the surface interval, nd indicates a refractive index in response to a d-line, vd (also denoted as “vd”) indicates an abbe number in response to a d-line, the effective diameter is a distance measured perpendicularly to the optical axis from the optical axis through the height of a maximum surrounding ray passing through the plane, and a surface with an asterisk (*) is an aspheric surface. The aspheric shape is defined by the following Equation:

$$Z = \frac{{h}^{2} / r}{1 + \sqrt{1 - ( 1 + κ ) {( h / r )}^{2}}} + \sum {A}_{n} {h}^{n}$$

where Z is the distance from a point on an aspheric surface, located at a height h as measured from the optical axis, to a tangent plane defined with respect to the vertex of the aspheric surface, h is the height as measured from the optical axis, r is the radius of curvature of the vertex, κ is a conic constant, and An is an nth order aspheric surface coefficient.

FIGS. 1B, 2B, 3B, and 4B are longitudinal aberration diagrams showing what state the imaging optical systems according to the first, second, third, and fourth examples of numerical values assume.

In each longitudinal aberration diagram, portion (a) shows the longitudinal aberrations in the infinity in-focus state, and portion (b) shows the longitudinal aberrations in the close-object in-focus state. Each of portions (a) and (b) of these longitudinal aberration diagrams shows spherical aberration (SA (mm)), astigmatism (AST (mm)), and distortion (DIS (%)) in this order from left to right. In each spherical aberration diagram, the ordinate indicates the F number (designated by “F” on the drawings), the solid curve indicates a characteristic in response to a d-line, the shorter dashed curve indicates a characteristic in response to an F-line, and the longer dashed curve indicates a characteristic in response to a C-line. In each astigmatism diagram, the ordinate indicates the image height (designated by “H” on the drawings), the solid curve indicates a characteristic with respect to a sagittal plane (designated by “s” on the drawings), and the dotted curve indicates a characteristic with respect to a meridional plane (designated by “m” on the drawings). Furthermore, in each distortion diagram, the ordinate indicates the image height (designated by “H” on the drawings).

### First Example of Numerical Values

TABLE 1A
(Surface data)

| | | | | | Effective |
|---|---|---|---|---|---|
| Surface No. | r | d | nd | vd | diameter |
| Object surface | ∞ | Variable | | | |
| 1* | −8.65700 | 1.00000 | 1.53504 | 55.7 | 5.372 |
| 2* | −32.87850 | 0.76690 | | | 4.592 |
| 3 (Aperture) | ∞ | 0.33000 | | | 3.900 |
| 4* | 11.22640 | 2.83530 | 1.53504 | 55.7 | 4.746 |
| 5* | −21.40270 | 2.76000 | | | 4.500 |
| 6* | −43.36530 | 3.40360 | 1.53504 | 55.7 | 5.556 |
| 7* | −8.90430 | 2.57790 | | | 6.231 |
| 8* | −3.84940 | 3.70670 | 1.65731 | 21.2 | 6.397 |
| 9* | −9.45130 | 1.19510 | | | 8.563 |
| 10* | 7.58240 | 2.92440 | 1.53504 | 55.7 | 12.999 |
| 11* | 16.52250 | Variable | | | 13.227 |
| 12 | ∞ | 2.10000 | 1.51680 | 64.2 | |
| 13 | ∞ | 1.00000 | | | |
| 14 | ∞ | BF | | | |
| Image plane | ∞ | | | | |

TABLE 1B
(Aspheric surface data)

1^{st} surface
K = 5.31630E−01, A4 = 2.22724E−03, A6 = −6.20115E−05, A8 = 2.03677E−06
A10 = −3.97029E−08, A12 = 3.85282E−10, A14 = −1.09379E−16
2^{nd} surface
K = 0.00000E+00, A4 = 1.16869E−03, A6 = −2.66816E−06, A8 = −4.18934E−07
A10 = 2.65515E−08, A12 = 0.00000E+00, A14 = 0.00000E+00
4^{th} surface
K = 0.00000E+00, A4 = −1.20138E−03, A6 = 3.53432E−05, A8 = −1.76419E−06
A10 = 2.59025E−08, A12 = 0.00000E+00, A14 = 0.00000E+00
5^{th} surface
K = 0.00000E+00, A4 = −7.66982E−04, A6 = −4.51133E−06, A8 = −1.24786E−08
A10 = −7.28084E−09, A12 = 9.99430E−11, A14 = 0.00000E+00
6^{th} surface
K = 0.00000E+00, A4 = −6.52331E−04, A6 = −1.17374E−05, A8 = 2.13956E−07
A10 = −3.43681E−09, A12 = 2.02053E−10, A14 = −3.41283E−12
7^{th} surface
K = −4.53181E−01, A4 = −2.87799E−04, A6 = −6.07098E−06, A8 = −3.30975E−07
A10 = 1.70395E−08, A12 = −2.48554E−10, A14 = 3.67673E−14
8^{th} surface
K = −7.74103E−01, A4 = 2.16786E−03, A6 = −6.33393E−05, A8 = 1.70626E−06
A10 = −1.00326E−08, A12 = −2.86534E−10, A14 = 4.16765E−12
9^{th} surface
K = 0.00000E+00, A4 = 8.56406E−05, A6 = 8.27047E−06, A8 = −2.31563E−07
A10 = 5.44602E−09, A12 = −6.18853E−11, A14 = 3.02930E−13
10^{th} surface
K = −4.57568E+00, A4 = 6.88528E−05, A6 = −2.04899E−06, A8 = −3.67590E−09
A10 = 1.51362E−10, A12 = −6.54998E−13, A14 = 8.80953E−16
11^{th} surface
K = 0.00000E+00, A4 = −1.53882E−05, A6 = −3.02341E−06, A8 = 1.90678E−08
A10 = −4.84851E−11, A12 = 6.32345E−14, A14 = 0.00000E+00

TABLE 1C
(Various types of data in infinity in-focus
state and close-object in-focus state)

| | Infinity | Close-object |
|---|---|---|
| Focal length | 21.3171 | 21.3171 |
| F number | 2.91374 | 3.13378 |
| Angle of view | 45.4058 | 43.2589 |
| Image height | 19.0940 | 19.4950 |
| Total optical length | 37.0000 | 40.0321 |
| BF | −0.09987 | −0.09987 |
| d0 | ∞ | 159.9625 |
| d11 | 12.5000 | 15.5321 |
| Entrance pupil position | 1.3122 | 1.3122 |
| Exit pupil position | −39.9407 | −42.9727 |
| Anterior principal point | 11.2235 | 11.2235 |
| Posterior principal point | 15.6830 | 15.6830 |

TABLE 1D
(Data about single lenses)

| Lens | Start surface | Focal length |
|---|---|---|
| 1 | 1 | −22.2838 |
| 2 | 4 | 14.1931 |
| 3 | 6 | 20.2456 |
| 4 | 8 | −13.3961 |
| 5 | 10 | 23.5107 |

### Second Example of Numerical Values

TABLE 2A
(Surface data)

| | | | | | Effective |
|---|---|---|---|---|---|
| Surface No. | r | d | nd | vd | diameter |
| Object surface | ∞ | Variable | | | |
| 1 (Aperture) | ∞ | 0.33000 | | | 1.771 |
| 2* | 11.49150 | 1.87640 | 1.53504 | 55.7 | 2.182 |
| 3* | 24.41460 | 3.69120 | | | 2.795 |
| 4 | −22.60080 | 2.95790 | 1.81600 | 46.6 | 4.853 |
| 5 | −8.23450 | 2.74910 | | | 5.485 |
| 6 | −6.87890 | 1.00000 | 1.60817 | 29.3 | 5.749 |
| 7 | 143.98310 | 2.24020 | | | 8.203 |
| 8 | 110.41290 | 3.50520 | 2.00100 | 29.1 | 12.400 |
| 9 | −59.95300 | Variable | | | 12.911 |
| 10 | ∞ | 2.10000 | 1.51680 | 64.2 | |
| 11 | ∞ | 1.00000 | | | |
| 12 | ∞ | BF | | | |
| Image plane | ∞ | | | | |

TABLE 2B
(Aspheric surface data)

2^{nd} surface
K = 0.00000E+00, A4 = −2.29466E−04, A6 = 1.46226E−04, A8 = −4.10743E−05
A10 = 3.70762E−06
3^{rd} surface
K = 0.00000E+00, A4 = 3.80191E−04, A6 = −3.17775E−05, A8 = 1.95653E−06
A10 = −4.91767E−08

TABLE 2C
(Various types of data in infinity in-focus
state and close-object in-focus state)

| | Infinity | Close-object |
|---|---|---|
| Focal length | 28.3752 | 28.3752 |
| F number | 8.01107 | 9.61345 |
| Angle of view | 37.3263 | 32.4236 |
| Image height | 21.1950 | 20.9720 |
| Total optical length | 34.0002 | 40.0404 |
| BF | 0.05019 | 0.05019 |
| d0 | ∞ | 159.9598 |
| d9 | 12.5000 | 18.5403 |
| Entrance pupil position | 0.0000 | 0.0000 |
| Exit pupil position | −30.1479 | −36.1882 |
| Anterior principal point | 1.7129 | 1.7129 |
| Posterior principal point | 5.6250 | 5.6250 |

TABLE 2D
(Data about single lenses)

| Lens | Start surface | Focal length |
|---|---|---|
| 1 | 2 | 38.6220 |
| 2 | 4 | 14.5311 |
| 3 | 6 | −10.7681 |
| 4 | 8 | 39.2200 |

### Third Example of Numerical Values

TABLE 3A
(Surface data)

| | | | | | Effective |
|---|---|---|---|---|---|
| Surface No. | r | d | nd | vd | diameter |
| Object surface | ∞ | Variable | | | |
| 1 (Aperture) | ∞ | 0.33000 | | | 1.936 |
| 2 | 17.30230 | 1.54630 | 1.43700 | 95.1 | 2.423 |
| 3 | 197.03810 | 3.12200 | | | 3.085 |
| 4 | −4.63680 | 1.43620 | 2.00100 | 29.1 | 3.880 |
| 5 | −5.58620 | 0.30000 | | | 4.789 |
| 6 | 213.84700 | 4.17130 | 1.81600 | 46.6 | 7.065 |
| 7 | −11.97070 | 2.46280 | | | 7.518 |
| 8 | −9.65220 | 1.00000 | 1.65388 | 26.1 | 7.471 |
| 9 | 168.93730 | 1.21500 | | | 9.420 |
| 10 | 31.69380 | 2.86650 | 1.81055 | 41.1 | 12.601 |
| 11* | 300.00000 | Variable | | | 12.764 |
| 12 | ∞ | 2.10000 | 1.51680 | 64.2 | |
| 13 | ∞ | 1.00000 | | | |
| 14 | ∞ | BF | | | |
| Image plane | ∞ | | | | |

TABLE 3B
(Aspheric surface data)

11^{th} surface
K = 0.00000E+00, A4 = 5.03539E−05, A6 = −1.84261E−07, A8 = 6.79258E−10
A10 = −1.25416E−12

TABLE 3C
(Various types of data in infinity in-focus
state and close-object in-focus state)

| | Infinity | Close-object |
|---|---|---|
| Focal length | 22.6563 | 22.6563 |
| F number | 5.85131 | 6.51229 |
| Angle of view | 43.8222 | 41.0683 |
| Image height | 19.5960 | 19.9170 |
| Total optical length | 34.0001 | 37.5161 |
| BF | −0.05000 | −0.05000 |
| d0 | ∞ | 162.4840 |
| d11 | 12.5000 | 16.0160 |
| Entrance pupil position | 0.0000 | 0.0000 |
| Exit pupil position | −31.1753 | −34.6913 |
| Anterior principal point | 6.1646 | 6.1646 |
| Posterior principal point | 11.3438 | 11.3438 |

TABLE 3D
(Data about single lenses)

| Lens | Start surface | Focal length |
|---|---|---|
| 1 | 2 | 43.2915 |
| 2 | 4 | −112.0470 |
| 3 | 6 | 14.0086 |
| 4 | 8 | −13.9327 |
| 5 | 10 | 43.5125 |

### Fourth Example of Numerical Values

TABLE 4A
(Surface data)

| | | | | | Effective |
|---|---|---|---|---|---|
| Surface No. | r | d | nd | vd | diameter |
| Object surface | ∞ | Variable | | | |
| 1 (Aperture) | ∞ | 0.33000 | | | 1.552 |
| 2 | 11.62450 | 1.48810 | 1.43700 | 95.1 | 2.001 |
| 3 | 40.11130 | 2.44460 | | | 2.595 |
| 4 | −4.77310 | 1.00000 | 1.94595 | 18.0 | 3.336 |
| 5 | −5.78950 | 0.30000 | | | 3.987 |
| 6 | −67.46760 | 3.13000 | 1.81600 | 46.6 | 5.250 |
| 7 | −9.80600 | 4.02770 | | | 5.813 |
| 8 | −7.36270 | 1.00000 | 1.69513 | 24.0 | 6.205 |
| 9 | −61.66430 | 1.29370 | | | 8.586 |
| 10 | −59.76830 | 3.43580 | 2.00100 | 29.1 | 10.031 |
| 11 | −21.52680 | Variable | | | 10.798 |
| 12 | ∞ | 2.10000 | 1.51680 | 64.2 | |
| 13 | ∞ | 1.00000 | | | |
| 14 | ∞ | BF | | | |
| Image plane | ∞ | | | | |

### Table 4B: Aspheric Surface Data

### None

TABLE 4C
(Various types of data in infinity in-focus
state and close-object in-focus state)

| | Infinity | Close-object |
|---|---|---|
| Focal length | 24.7165 | 24.7165 |
| F number | 7.96280 | 9.00883 |
| Angle of view | 41.1960 | 37.7225 |
| Image height | 19.7600 | 19.9200 |
| Total optical length | 33.9990 | 38.2727 |
| BF | −0.05087 | −0.05087 |
| d0 | ∞ | 161.7260 |
| d11 | 12.5000 | 16.7736 |
| Entrance pupil position | 0.0000 | 0.0000 |
| Exit pupil position | −32.5834 | −36.8571 |
| Anterior principal point | 5.9382 | 5.9382 |
| Posterior principal point | 9.2825 | 9.2825 |

TABLE 4D
(Data about single lenses)

| Lens | Start surface | Focal length |
|---|---|---|
| 1 | 2 | 36.8697 |
| 2 | 4 | −55.0887 |
| 3 | 6 | 13.7260 |
| 4 | 8 | −12.1195 |
| 5 | 10 | 32.1653 |

### Values Corresponding to Inequalities

Values, corresponding to the Inequalities (1) to (9), of the respective examples of numerical values are shown in the following Table 1:

| | | 1^{st} example | 2^{nd} example | 3^{rd} example | 4^{th} example |
|---|---|---|---|---|---|
| | | of | of | of | of |
| | | numerical | numerical | numerical | numerical |
| Condition | Inequality | values | values | values | values |
| (1) | Linf/Yinf | 1.938 | 1.604 | 1.735 | 1.721 |
| (2) | BLinf/Yinf | 0.812 | 0.738 | 0.794 | 0.787 |
| (3) | nd_LF1 | 1.53504 | 1.53504 | 1.43700 | 1.43700 |
| (4) | vd_LF1 | 55.7 | 55.7 | 95.1 | 95.1 |
| (5) | (R1_LR2 − R2_LR3)/ | −0.396 | −0.090 | −0.107 | −0.142 |
| | (R1_LR2 + R2_LR3) | | | | |
| (6) | L_ss_LR1R2/Yinf | 1.033 | 0.866 | 0.942 | 0.934 |
| (7) | L_tsum/L_LR1R2 | 0.645 | 0.509 | 0.597 | 0.545 |
| (8) | EA_LIR1/find | 0.252 | 0.077 | 0.107 | 0.081 |
| (9) | L_ss_LF1R1/Yinf | 0.017 | 0.016 | 0.017 | 0.017 |

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

### INDUSTRIAL APPLICABILITY

The imaging optical system according to the present disclosure is applicable to various types of cameras including digital still cameras, lens interchangeable digital cameras, digital camcorders, cameras for cellphones and smartphones, and cameras for personal digital assistants (PDAs), surveillance cameras for surveillance systems, Web cameras, and onboard cameras. Among other things, the present disclosure is particularly effectively applicable as an imaging optical system for digital still camera systems, digital camcorder systems, and other camera systems that require high image quality.

1. An imaging optical system comprising:
an aperture stop;
a lens LF1 having positive power and located closer to an image plane than, and adjacent to, the aperture stop;
a lens LR1 having positive power and located closest to the image plane;
a lens LR2 having negative power and located closer to an object than, and adjacent to, the lens LR1; and
a lens LR3 having positive power and located closer to the object than, and adjacent to, the lens LR2,
an object-side surface of the lens LR2 being convex toward the image plane,
an image-side surface of the lens LR3 being convex toward the image plane, and
the imaging optical system satisfying the following inequalities (1) and (2):
$$0.5 < Linf / Yinf < 2.65 \qquad ( 1 )$$
$$0.5 < BLinf / Yinf < 2.0 \qquad ( 2 )$$
where Linf is a total optical length of the imaging optical system in an infinity in-focus state,
Yinf is an image height of the imaging optical system in the infinity in-focus state, and
Blinf is a distance from an image-side surface of the lens LR1 located closest to the image plane to the image plane when the imaging optical system is in the infinity in-focus state.

2. The imaging optical system of claim 1, further comprising a lens group having negative power and located not only closest to the object but also closer to the object than, and adjacent to, the aperture stop.

3. The imaging optical system of claim 1, further comprising a lens having negative power and located closer to the object than, and adjacent to, the aperture stop.

4. The imaging optical system of claim 1, wherein
the imaging optical system satisfies the following inequality (3):
$$nd\_LF1 < 1.65 \qquad ( 3 )$$
where nd_LF1 is a refractive index of the lens LF1.

5. The imaging optical system of claim 1, wherein
the imaging optical system satisfies the following inequality (4):
$$50 < vd\_LF1 \qquad ( 4 )$$
where vd_LF1 is an abbe number of the lens LF1.

6. The imaging optical system of claim 1, wherein
a lens located closer to the image plane than, and adjacent to, the lens LF1 has an object-side surface convex toward the image plane.

7. The imaging optical system of claim 1, comprising a plurality of lenses located closer to the image plane than the aperture stop is, a numerical number of the plurality of lenses being equal to or greater than three and equal to or less than six.

8. The imaging optical system of claim 1, wherein
while the imaging optical system is focusing to make a transition from the infinity in-focus state to a close-object in-focus state, at least a plurality of lenses, ranging from the lens LF1 located closer to the image plane than, and adjacent to, the aperture stop through the lens LR1 located closest to the image plane, are configured to move along with each other.

9. The imaging optical system of claim 1, wherein
the imaging optical system satisfies the following inequality (5):
$$- 1. < ( R1\_LR2 - R2\_LR3 ) / ( R1\_LR2 + R2\_LR3 ) < 0.5 \qquad ( 5 )$$
where R1_LR2 is a radius of curvature of an object-side surface of the lens LR2, and
R2 LR3 is a radius of curvature of an image-side surface of the lens LR3.

10. The imaging optical system of claim 1, wherein
the imaging optical system satisfies the following inequality (6):
$$0.5 < L\_ss \_LR1R2 / Yinf < 3. \qquad ( 6 )$$
where L_ss_LR1R2 is a distance from the aperture stop to an image-side surface of the lens LR1 when the imaging optical system is in the infinity in-focus state, and
Yinf is an image height of the imaging optical system in the infinity in-focus state.

11. The imaging optical system of claim 1, wherein
the imaging optical system satisfies the following inequality (7):
$$0.2 < L\_tsum / L\_LR1R2 < 0.9 \qquad ( 7 )$$
where L_tsum is a sum of respective thicknesses of all lenses included in the imaging optical system, and
L_LR1R2 is a distance measured on an optical axis of the imaging optical system from a surface, located closest to the object, of the imaging optical system to an image-side surface of the lens LR1 located closest to the image plane.

12. The imaging optical system of claim 1, wherein
the imaging optical system satisfies the following inequality (8):
$$0.03 < EA\_L1R1 / finf < 0.5 \qquad ( 8 )$$
where EA_L1R1 is an effective diameter of an object-side surface of a lens located closest to the object, and
finf is a focal length of the imaging optical system in the infinity in-focus state.

13. The imaging optical system of claim 1, wherein
the imaging optical system satisfies the following inequality (9):
$$0.01 < L\_ss \_LF1R1 / Yinf < 0.2 \qquad ( 9 )$$
where L_ss_LF1R1 is a distance measured on an optical axis of the imaging optical system from the aperture stop to an object-side surface of the lens LF1 when the imaging optical system is in the infinity in-focus state, and
Yinf is an image height of the imaging optical system in the infinity in-focus state.

14. The imaging optical system of claim 1, wherein
either the aperture stop or a lens having power and located closer to the object than, and adjacent to, the aperture stop is located closest to the object in the imaging optical system.

15. An image capture device configured to transform an optical image of an object into an electrical image signal and display and/or store the electrical image signal thus transformed, the image capture device comprising:
the imaging optical system of claim 1 configured to form the optical image of the object; and
an image sensor configured to transform the optical image formed by the imaging optical system into the electrical image signal.

16. A camera system comprising:
an interchangeable lens unit including the imaging optical system of claim 1; and
a camera body including: an image sensor configured to receive an optical image of an object formed by the imaging optical system and transform the optical image into an electrical image signal; and a camera mount, the camera body being configured to be connected removably to the interchangeable lens unit via the camera mount,
the interchangeable lens unit being configured to form the optical image of the object on the image sensor.
